(19) United States
(12) Patent Application Publication
(10) Pub. No.: US 2001/0052206 A1
(43) Pub. Date: Dec. 20, 2001

(54) Crawling arthropod guard for boat docks and land vehicles

(76) Inventor: Ernest H. Roberts, Elyria, CA (US)

Correspondence Address: Fay, Sharpe, Fagan,, Minnich & McKee, LLP, 7th Floor, 1100 Superior Avenue, Cleveland, OH, 44114-2518, US

(21) Appl. No.: 09/843,669

(22) Filed: Apr. 26, 2001

Related U.S. Application Data
(60) Provisional application No. 60/199,785, filed on Apr. 26, 2000.

(51) Int. Cl. E04B 1/72; E04H 9/16; A01K 3/00; E04C 3/30

(52) U.S. Cl. 52/101; 52/426; 52/427; 52/578; 52/582.1; 114/343

(57) ABSTRACT

A guard for obstructing crawling arthropods from encroaching a moored watercraft or stationary object comprise a mounting panel and an outer panel. The outer panel is spaced from the mounting panel by at least one joining member. An arthropod barrier including an active arthropod deterring component situated between the mounting panel and outer panel.

This application claims priority from U.S. Provisional application Ser. No. 60/199,785, filed Apr. 26, 2000.

### BACKGROUND OF THE INVENTION

The present invention is directed to pest management and more particularly to controlling a route of travel of crawling arthropods and insects by interrupting their route of travel. The present invention is particularly applicable to a device for interrupting a route of travel of crawling arthropods onto boats moored at docks. The invention is also applicable to interrupting a route of travel of crawling arthropods into land vehicles such as recreational vehicles, campers, vans, automobiles, or any raised structure held up by wheels or other support.

When boats are moored, they are situated in parallel to a dock and tied or otherwise secured thereto. Docks are generally built from wood or other resilient material. Some docks include a bumper that eases the contact between the dock and the boat. The contact, whether between a boat and a bumper or a boat and the dock, enables crawling arthropods to encroach directly onto the boat as unwelcome passengers.

When land vehicles such as recreational vehicles, campers, vans, automobiles or the like are parked in areas susceptible to crawling arthropods, the arthropods make there way into the vehicles by crawling along the wheels or support stanchions and into the passenger area. This is particularly undesirable when camping or sleeping in the vehicle.

There is a need to develop a device that interrupts the route of travel of crawling arthropods and other vermin from a dock onto a boat moored to that dock, or from the ground, concrete enclosure or parking surface into a land vehicle.

### SUMMARY OF THE INVENTION

In accordance with the present invention there is provided a novel barrier, guard or bumper structure that obstructs a route of travel of crawling arthropods or other crawling or slithering or walking vermin from encroaching a boat moored to a dock or a land vehicle.

In accordance with a more limited aspect of the invention, a barrier comprises a mounting panel and an outer panel spaced therefrom and joined by a plurality of elongated members. A crawling arthropod deterring device is secured to each elongated member of the barrier. The arthropod deterring device comprises a portion and a skirt portion. A vapor head is created in the skirt portion as a result of the presence of an arthropod deterring component situated within the skirt.

An advantage of the present invention is that the bumper device can be retrofit to existing docks.

Another advantage of the present invention is that it can be modified to provide a base for land vehicles to rest or set upon a stanchion particularly during recreational camping or storage.

Another advantage of the present invention is that the device stops a route of travel of crawling arthropods onto a boat or vehicle.

Yet another advantage of the invention resides in the fact that the device does not hamper one's ability to enter a boat. The device is small enough to allow one to simply step over it into or out of the boat on to the dock.

Still another advantage of the present invention is that the active arthropod deterring ingredient is maintained within the arthropod deterring device and does not require significant human contact. The device is simple to replace upon repletion of the active ingredient.

Still other advantages will become apparent to those skilled in the art upon a reading and understanding of the following detailed description.

### BRIEF DESCRIPTION OF THE DRAWINGS

The invention may take physical form in certain parts and arrangements of parts, a preferred embodiment which will be described in detail in the specification and illustrated in the accompanying drawings which form a part hereof.

FIG. 1 sets forth a perspective view of a preferred embodiment guard or bumper for separating a boat from a boat dock.

FIG. 2 discloses a side view of the guard or bumper of FIG. 1 as it is installed in a boat dock environment.

FIG. 3 displays an alternative embodiment of a bumper or guard for a boat dock.

FIG. 4 discloses an alternative embodiment guard which is useful in conjunction with separating land vehicles from the ground.

### DETAILED DESCRIPTION OF THE PREFERRED EMBODIMENTS

The present invention is directed to a dock bumper designed to interrupt a route of travel of crawling arthropods and other vermin between a dock and a moored boat. The bumper, shown in FIG. 1, comprises a mounting panel 10, an outer panel 14, and a plurality of elongated joining members 18 which connect longitudinally between the mounting panel and outer panel. The connecting members are shown to be fastened to each panel such as by flat head lug bolts 22 or other fasteners. The mounting panel and outer panel are comprised of virtually any material that will withstand constant exposure to sea or fresh water and which is durable to withstand the force of a boat bouncing into it. The panels can be solid or they can be latticed or of virtually any arrangement provided they meet the qualifications of structural strength and durability. The panels are spaced in parallel relation from one another and are connected via at least one of the joining members 18.

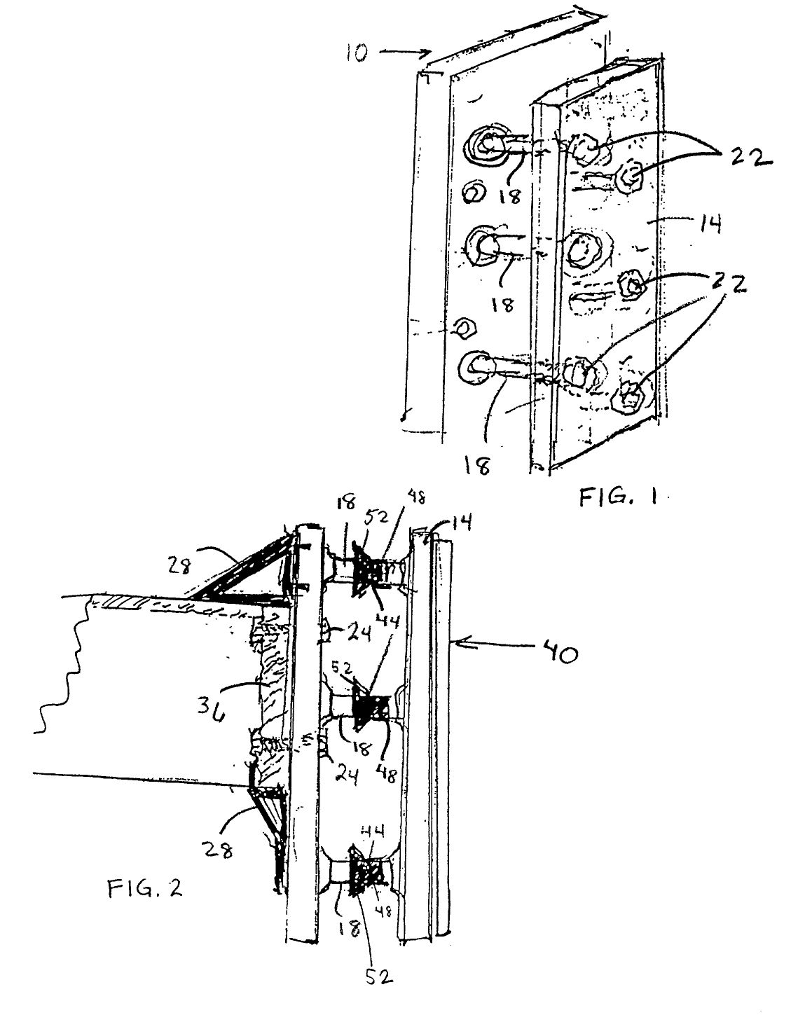

The bumper or guard is fastened or otherwise secured to a dock. By way of example, as shown in FIG. 2, the mounting panel can be secured to the dock by lug bolts 24, although any suitable fastening device can be used. Optionally, a support bracket 28 can be placed on the top surface of the dock, and another 32 below. The support brackets are particularly useful if the mounting panel extends beyond the height of the dock wall 36. An optional padded or rubber bumper 40 is shown on the outer panel. The padded bumper softens the contact between the boat and the dock as they collide.

The elongated joining members 18 have crawling arthropod barriers 44 mounted to each. These barriers interrupt the route of travel of the crawling arthropods that are on the dock and seek to crawl directly onto the boat moored to the dock. The barriers include a collar portion 48 and a skirt portion 52. The crawling arthropod barriers are preferably comprised of a soft, flexible polymeric material into which an arthropod deterring ingredient has been molded, at least in the skirt portion. In the alternative, the barriers may contain or receive or otherwise have applied thereto the active arthropod deterring ingredient within the interior of the skirt portion. A vapor head develops in the skirt portion which then deters, kills or otherwise interrupts the route of travel of the crawling arthropods.

The arthropod deterring component may comprise any component that deters arthropods, including gels, insecticides, pesticides, repellants, sticky substances, or the like. A preferred embodiment comprises Permethrin molded directly into the skirt.

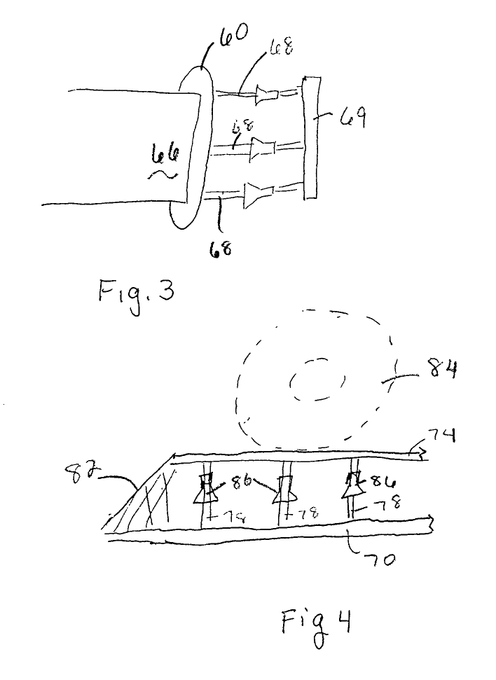

With attention now on FIG. 3, a fastening plate 60 includes curved returns 64 at either end. The fastening plate is adjustable vertically to clamp or brace the device to the dock 66. A plurality of elongated joining members 68 connect the fastening plate 60 to an outer panel 69.

The dock guard is adjustable horizontally. The panel members are designed to telescope so the longitudinal dimension can be adjusted to adapt to a desired length along a dock.

An alternative embodiment of the subject guard is depicted in FIG. 4. The guard of FIG. 4 is designed to support a land vehicle. The guard comprises a base panel 70 and an upper panel 74. The panels are spaced by a plurality of supporting elongated members 78. The panels and elongated support members are comprised of a durable material that can withstand the weight of a vehicle. The panels can be comprised of solid pieces, lattice work pieces or the like, provided they are durable. A ramp 82 is positioned adjacent the guard. A land vehicle, such as an automobile, recreational vehicle, camper, or the like is driven up onto a plurality of these guards. A guard is positioned in front of each vehicle wheel, with the ramp placed facing the wheels. The land vehicle is driven up the ramps onto the guard and then parked on the ramp for the duration of the stay at the camp sight or other location. Wheels 84 or other vehicle support members rest on each guard. The ramp is removed to prevent crawling arthropods from finding a path from the ground or other parking surface to the wheel or stanchion which supports the vehicle. The elongated support members 78 each include a crawling arthropod deterring device 86 such as that described above with respect to FIG. 2. Crawling arthropods are deterred from the vehicle by the deterring devices. There is no other path for the crawling vermin to reach the vehicle.

The device is not limited to the uses stated herein. For example, it can be used in a variety of situations such as in association with kitchen stations, mess stations, military applications, concession stands, stationary buildings, mobile homes or in association with virtually any structure that should be protected from crawling arthropods. The device can be installed permanently and fixed (with the ability to replace the deterring device). Or it can be portable or temporary.

The invention has been described with reference to the preferred embodiment. Obviously modification and alterations will occur to others upon a reading and understanding of this specification. It is intended to include all such modifications and alterations.

Having thus described the preferred embodiment, the invention is now claimed to be:

1. A guard for obstructing a route of crawling arthropods from encroaching a moored watercraft or a stationary object, comprising:
a mounting panel;
an outer panel spaced from said mounting panel by at least one joining member; and
an arthropod barrier situated between said mounting panel and said outer panel.

2. The guard of claim 1 wherein the arthropod barrier comprises a collar portion and a skirt portion, the collar portion received about the joining member.

3. The guard of claim 2 wherein the skirt portion is outwardly flared toward the mounting panel.

4. The guard of claim 3 wherein an active arthropod-deterring component is associated with the arthropod barrier.

5. The guard of claim 4 wherein the arthropod-deterring component is molded directly in the material from which the arthropod barrier is made.

6. The guard of claim 4 wherein the arthropod deterring component is applied to the arthropod barrier.

7. The guard of claim 4 wherein a vapor head is created within the skirt portion as a result of the arthropod-deterring component.

8. The guard of claim 4 wherein the mounting panel is adapted for fastening to a dock.

9. The guard of claim 8 wherein the outer panel is situated in parallel relation to the mounting panel.

10. The guard of claim 8 wherein a padded bumper is affixed to an exterior plane of the outer panel to soften contact between a watercraft and a dock.

11. The guard of claim 4 wherein the mounting panel is situated horizontally on a surface for supporting a stationary object.

12. The guard of claim 11 wherein the outer panel is situated horizontally on a surface for supporting a parked recreational vehicle.

13. The guard of claim 12 wherein the outer panel is situated above and in parallel relation to the mounting panel.

14. The guard of claim 13 wherein the outer panel terminates in a downwardly extending ramp.

15. The guard of claim 14 wherein the guard is adapted to support a wheel or stanchion of a vehicle.
